(19) United States
(12) Patent Application Publication
(10) Pub. No.: US 2016/0335552 A1
(43) Pub. Date: Nov. 17, 2016

(54) METHOD AND SYTEM FOR CROWD DETECTION IN AN AREA

(71) Applicant: NEC EUROPE LTD., Heidelberg (DE)

(72) Inventors: Salvatore LONGO, Mantova (IT); Miquel MARTIN LOPEZ, London (GB)

(21) Appl. No.: 15/110,409

(22) PCT Filed: Jan. 15, 2014
(86) PCT No.: PCT/EP2014/050691

§ 371 Date: Jul. 8, 2016

(51) Int. Cl. G06N 5/04; G06N 7/00; G06N 99/00

(52) U.S. Cl. CPC G06N 5/047; G06N 99/005; G06N 7/005

(57) ABSTRACT

A method for crowd detection in an area includes determining moving patterns of persons in the area and the number of persons within and/or moving from and/or to the area over a certain time period to obtain model training data sets; assigning each model training data set to represent one of one or more predefined crowd levels in the area; generating a crowd detection model based on the model training data sets; and estimating an actual crowd level for the area using the generated crowd detection model with actual data of moving profiles and/or the actual number of persons within and/or moving from and/or to the area over a certain time period.

### CROSS REFERENCE TO RELATED APPLICATIONS

This application is a U.S. National Stage Application under 35 U.S.C. §371 of International Application No. PCT/EP2014/050691, filed on Jan. 15, 2014. The International Application was published in English on Jul. 23, 2015 as WO 2015/106808 A1 under PCT Article 21(2).

### FIELD

The present invention relates to a method and to a system for crowd detection, for example a crowd of people, in an area, for example an indoor area.

### BACKGROUND

Crowd detection in an area is for example important for civil safety or heritage conservations. For instance, access to a building can be limited when a safe evacuation due to crowd formation is not possible anymore. Another example is to limit access to a national park to avoid damage of the environment, etc.

Conventional methods for crowd detection use video surveillance cameras, which are optionally connected to face detection systems to assess the number of persons in the area. However, these systems involve high economic costs and cause serious privacy issues. For example such systems need to abide by a rather complex privacy regulation making it hard for export to different countries and may limit functionality.

Another problem is that certain areas are not open to video cameras, for example rest rooms or other locations where customers are likely to value their privacy. A further problem is, that the accuracy of video cameras may be seriously compromised by occlusions in case of large crowds, diminishing its usefulness in cases when they are more critical.

In the non-patent literature of Alexandra Moraru, Marko Pesko, Maria Porcius, Carolina Fortuna, Dunja Mladenic, “Using Machine Learning on Sensor Data” in the Journal of Computing and Information Technology—CIT 18, 2010, 4, 341-347, doi: 10.2498/CIT.11913, sensors such as humidity, temperature or light sensors are used together with machine learning techniques to detect a crowd. However, this method suffers low accuracy when detecting a crowd.

### SUMMARY

In an embodiment, the present invention provides a method for crowd detection in an area that includes determining moving patterns of persons in the area and the number of persons within and/or moving from and/or to the area over a predetermined time period to obtain model training data sets; assigning each model training data set to represent one of one or more predefined crowd levels in the area; generating a crowd detection model based on the model training data sets; and estimating an actual crowd level for the area using the generated crowd detection model with actual data of moving profiles and/or the actual number of persons within and/or moving from and/or to the area over the predetermined time period.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIGS. 1a, b show scenarios for crowd detection with a system according to a first embodiment of the present invention;

FIGS. 2a, b show scenarios for crowd detection with a system according to a second embodiment of the prevent invention;

FIG. 3a shows a non-crowd scenario for a room with a system according to a third embodiment of the prevent invention;

FIG. 3b shows a crowd scenario for a room with a system according to a fourth embodiment of the prevent invention;

FIG. 4 shows part of a system according to a fifth embodiment of the present invention; and

FIG. 5 shows part of the steps for crowd detection according to a sixth embodiment of the present invention.

### DETAILED DESCRIPTION

Embodiments of the present invention provide a method and a system for crowd detection ensuring privacy more economical and less error prone than conventional methods and systems.

A method according to an embodiment is characterized in that moving patterns of persons in the area and the number of persons within and/or moving from and/or to the area over a certain time period are determined to obtain model training data sets, that said model training data sets are each assigned to represent one of one or more predefined crowd levels in the area, that a crowd detection model is generated based on the model training data sets, and that an actual crowd level for the area is estimated using the generated crowd detection model with actual data of moving profiles and/or the actual number of persons within and/or moving from or to the area over a certain time period.

A system according to an embodiment is characterized by data collection means connected to one or more sensors operable to determine moving patterns of persons in the area and the number of persons within and/or moving from or to the area over a certain time period, data set creation means operable to prepare the collected data of moving patterns of persons in the area and the number of persons within and/or moving from and/or to the area, classifier means operable to classify one of predefined crowd levels in the area for the prepared data, model generation means operable to generate a crowd detection model based on the classified data and crowd detection means operable to estimate an actual crowd level for the area using the generated crowd detection model with actual data of moving profiles and/or the actual number of persons within and/or moving from and/or to the area over the certain time period.

According to an embodiment of the invention it has been recognized that by determining moving patterns of persons in the area and a number of persons moving from the area and/or to the area over a certain time period and assigning crowd levels to the obtained training sets a high accuracy as well as an easy implementation and fast execution of the method and system for crowd detection can be obtained.

According to an embodiment of the invention it has been further recognized that costs are reduced, since for example the number of persons can be easily determined without expensive cameras in particular without face recognition or the like.

According to an embodiment of the invention it has been further recognized that the model training data sets can be obtained with high accuracy over a predetermined period of time therefore resulting in lesser costs, since for example expensive video cameras for obtaining a model data set can be lent for some days which is much more cost-effective than buying and maintaining the cameras. A complete camera system would take at least as many cameras as there are accesses to an area while a camera system needed temporarily for training would only have to cover selected areas.

According to an embodiment of the invention it has been even further recognized that privacy is preserved, since moving patterns of persons and a number of persons do not require an identification of privacy concerning features of persons. Moving patterns of a person can be obtained without identifying the person. According to an embodiment of the invention it has been further recognized that for the crowd detection a reduced number of sensors is needed, thus, costs are reduced. According to an embodiment of the invention it has been further recognized that a sufficient accuracy for crowd detection can be achieved. According to an embodiment of the invention it has been further recognized that by using moving profiles or more generally speaking human interactions represented by the moving patterns of person dynamics of a crowd can therefore be reliably determined.

According to a preferred embodiment the crowd detection model is generated using a machine learning algorithm on the model training data sets. Using a machine learning algorithm enables to extract potential essential features representing the crowd levels of a vast variety of variables in the model training data sets and therefore to generate a crowd detection model efficiently. By using machine learning algorithms on the model training data sets a data set does not have to be prepared extensively: Raw sensor data can be used as input for the machine learning algorithm. Therefore flexibility is as well enhanced.

According to a further preferred embodiment for estimating the actual crowd level a machine learning algorithm is used with the actual data based on the generated crowd detection model. By using the machine learning algorithm with the actual data and based on the generated model training data sets respectively the generated crowd detection model based thereon a fast, reliable and efficient estimation whether a crowd scenario is present or not is enabled.

According to a further preferred embodiment the model data sets are analyzed with regard to an association between the crowd level and/or regions in which persons move with a probability greater than or equal to a predetermine threshold in the area and that based on the analyzed data the area is divided into one or more moving regions and one or more non-moving regions. This enables for example to identify key trajectory points for the crowd detection. This further enables for example to design or focus certain key points of rooms, corridors, etc. which can be identified as normal movement of persons and abnormal movement of persons enabling to design a more efficient corridor or rooms in case of, for example, an evacuation of a building.

According to a further preferred embodiment the non-moving regions are determined based on a predefined distance to one or more borders of the area. This takes into account that people tend to stay away from borders like walls of a room, etc. when passing through the room. Therefore by determining non-moving regions based on a predefined distance to one or more borders a fast and efficient way of defining non-moving regions is enabled.

According to a further preferred embodiment one or more sensors, preferably one or more privacy preserving sensors are arranged in the non-moving regions of the area. This allows for example to detect anomaly behavior in the area: For example usually people tend to avoid walking close to walls but will do so if a room or a corridor is crowded enough that no other option is available. When a sensor, preferably a privacy preserving sensor, is arranged in a non-moving region of the area, i.e. meaning that the sensor monitors this area, then a higher accuracy for crowd detection is provided. Further abnormal behavior of a person can also be detected not only in case of forming of a crowd but also for example estimate the length of a queue in a room in front of a desk or a cash point so that if the queue length exceeds a predetermined threshold a further check-out operative can be called for queue length reduction in the supermarket.

According to a further preferred embodiment one or more corridors are defined for moving to or leaving the area, wherein one or more sensors, preferably one or more privacy-preserving sensors, are arranged in at least one of the corridors. This enables to monitor the number of persons in the area more reliably, in the corridors and the estimated number of people in the near future in the area allowing a further enhanced accuracy for crowd detection.

According to a further preferred embodiment a privacy preserving sensor is provided in form of an environmental sensor, preferably in form of a CO2 sensor, temperature sensor, humidity sensor and/or noise sensor and/or a location sensors, preferably in form of a proximity sensor and/or a movement sensor. Privacy preserving sensors enable to determine parameters of environment and/or of location of persons but do not enable to identify a person. For example a CO2 sensor can detect then that based on the CO2 level how many persons are approximately in a room, but cannot identify each person individually. The same applies for a temperature sensor measuring the temperature of a room or a humidity sensor measuring the humidity within the room which for example is increased when more persons are in the room.

According to a further preferred embodiment of the system according to claim 9 analyzing means are operable to analyze the classified data with regard to an association between crowd level and regions in which persons move with a probability greater than or equal to a predetermined threshold in the area and that based on the analyzed data the area is divided into one or more moving regions and one or more non-moving regions. This enables for example to identify key trajectory points for the crowd detection. This allows for example to design or focus certain key points of rooms, corridors, etc. which can be identified as normal moving of persons and abnormal moving of persons enabling to design a more efficient corridor or rooms in case of, for example an evacuation of a building.

According to a further preferred embodiment of the system according to claim 9 one or more sensors, preferably one or more privacy preserving sensors are arranged in the non-moving regions of the area. This allows for example to detect anomaly behavior in the area: For instance people usually tend to avoid walking close to walls but will do so if a room or a corridor is crowded enough that no other option is available. When a sensor, preferably a privacy preserving sensor is arranged in the non-moving region of the area, i.e. meaning that the sensor monitors this area, then a higher accuracy for crowd detection is provided. Further abnormal behavior of a person can also be detected not only in case of forming of a crowd but also for example estimate the length of a queue in a room in front of a desk or a cash point so that if the queue length exceeds a predetermined threshold a further check-out operative can be called for queue length reduction in the supermarket.

According to a further preferred embodiment a privacy preserving sensor is an environmental sensor preferably a CO2 sensor, a temperature sensor, humidity sensor and/or noise sensor and/or location sensor, preferably a proximity sensor and/or a movement sensor. Privacy preserving sensors enable to determine parameters of environment and/or of location of persons but do not enable to identify a person. For example a CO2 sensor can detect then that based on the CO2 level how many persons are approximately in a room, but cannot identify each person. The same applies for a temperature sensor measuring the temperature of a room or a humidity sensor measuring the humidity within the room which for example is increased when more persons are in the room.

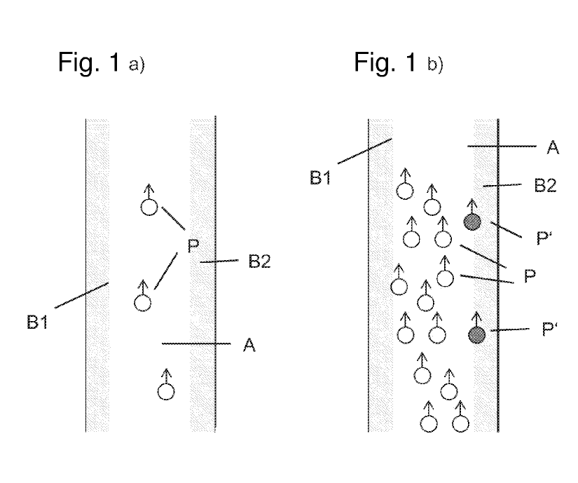

FIGS. 1a, b show scenarios for crowd detection of a system according to a first embodiment of the present invention. In FIG. 1a a corridor A with walls on the left and right is shown. Further within a predetermined distance of the walls of the corridor two regions B1 and B2 are marked in grey showing therefore regions which are defined to be close to the walls. In FIG. 1a persons P walk usually in the middle of the corridor A if there is no anomaly present.

In FIG. 1b a crowd scenario for the corridor A is shown. Some of the persons P, denoted with reference sign P′, are walking within the greyed area, i.e. are walking close to the wall in the region B2, so that it is likely that a crowd has been formed within the corridor A. By arranging or installing a proximity sensor monitoring the regions B1 and/or B2 the accuracy for crowd detection can be enhanced by only firing in cases when the corridor is crowded enough.

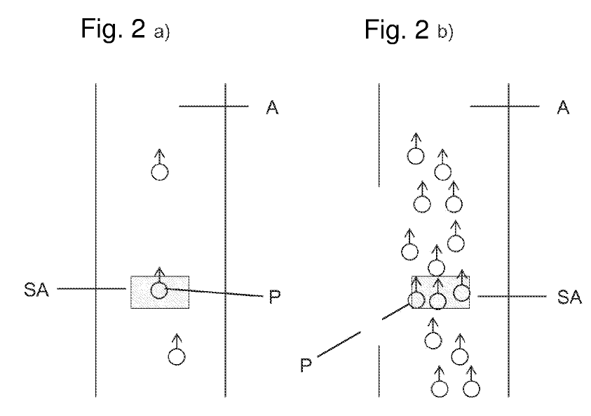

FIGS. 2a, b show scenarios for crowd detection with a system according to a second embodiment of the prevent invention. In FIG. 2a a further corridor A is shown in which persons P move in the middle when there is no anomaly present. A sensor monitoring a sensor area SA in the middle of the corridor A detects that only one person P is within the sensor area SA.

In FIG. 2b a crowd scenario is shown where three persons P are detected by the sensor in the sensor area SA. Usually in non-crowd scenarios as shown in FIG. 2a persons tend to leave a space between them. While occasional couples or groups of friends might walk shoulder to shoulder it is more normal for this to be the result of a crowded area which forces persons P together as shown in FIG. 2b. By arranging or placing contiguous sensors as shown in FIG. 2a and FIG. 2b single sensors will only fire in low crowded rooms and pairs or triplets of sensors will fire on crowded rooms as persons walk shoulder to shoulder. Such a behavior of persons is for example based on the non-patent-literature of Mehdi Moussaid, Dirk Helbing, Simon Gamier et al, “Experimental study of the behavioural mechanisms underlying self-organization in human crowds”.

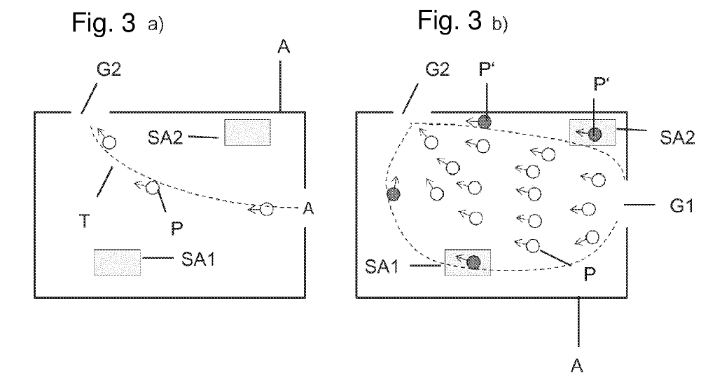

FIG. 3a shows a non-crowd scenario for a room with a system according to a 20 third embodiment of the prevent invention and FIG. 3b shows a crowd scenario for a room with a system according to a forth embodiment of the prevent invention. In FIGS. 3a and 3b persons following a typical trajectory on an empty room (FIG. 3a) and in a crowded room (FIG. 3b) is shown.

In FIG. 3a a rectangular room A is shown as well as two doors G1, G2. Persons P entering the room A via door G1 following the trajectory T which is more or less a path of less resistance or in other words the persons P usually trace a beeline from the first door G1 to the second door G2 in the same way according to visual queues, obstacles, etc.. Therefore the room A has “dead” regions where persons do not walk unless forced, for example by mobile obstacles, for example other persons or the like. By placing sensors monitoring this “dead” regions, for example in form of proximity or movement sensors, that are typically not visited, this enables to provide an insight how crowded the room is.

In FIG. 3a these regions SA1 and SA2 monitored by sensors are at a certain distance from the trajectory T close to at least one of the walls of the room A. In FIG. 3b the same room A, however now crowded, is shown. Therefore persons P′ are forced to walk in these “dead” regions of the room A and are then monitored by the sensors. Therefore by placing these sensors in the non-walking regions of a room A crowd detection, in particular the accuracy of the crowd detection, can be efficiently enhanced.

In particular sensors, preferably in form of motion and/or proximity sensors may be placed in the following way:
Close to walls in long corridors, where persons would not walk unless pushed in by a crowd.
Arranged perpendicular to the normal flow of persons in an area, so as to detect persons walking shoulder to shoulder or persons walking further apart.
In a corner of a room where there's no reason to walk, other than to avoid obstacles, e.g. crowds, in the room.
On one of the accesses to a fork, e.g. a corridor crossing, where the flow of persons in one access can be correlated to the flow in the other accesses.
Towards the end of a spot where a line is formed, since that will indicate that a line of persons of at least that length has been formed.
On appliances and devices: e.g. in recreation area when a person stands in front of a vending machine is correlated to the amount of persons in said area.
Close to the toilet area, where an estimation of the persons can be correlated to the amount of persons in the building.
A combination of the previous approaches duplicated along the path of motion, to better detect direction of the persons passing by the system.

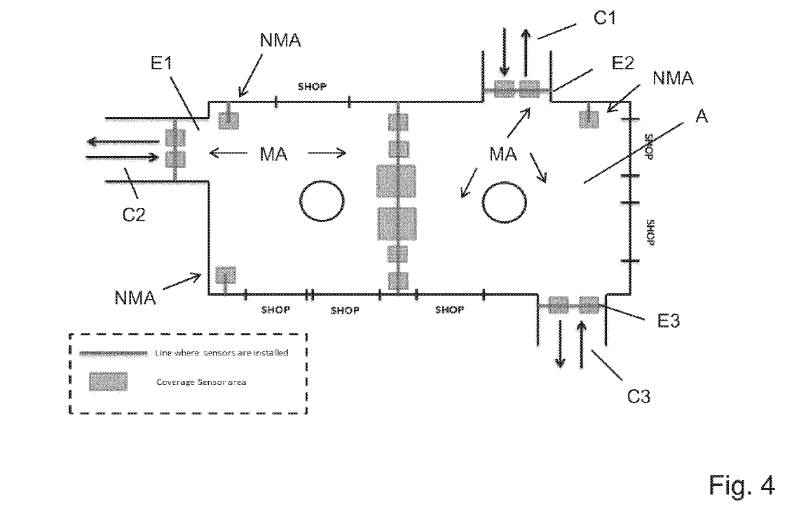

FIG. 4 shows part of a system according to a fifth embodiment of the present invention. In FIG. 4, a shopping mall A having three entrances E1, E2, E3 is shown. For each entrance E1, E2, E3 a corresponding corridor C1, C2, C3 is also shown which persons can use to enter or leave the shopping area A. In the middle of the shopping mall A there is provided a plurality of sensors dividing the shopping area.

A roughly in two parts enabling to determine the persons moving from one subarea to the other or vice versa. Therefore monitoring is enabled how persons are moving within the shopping area A. Further at the entrances E1 E2, E3 sensors are installed to determine the number of people entering or leaving the shopping area A. With these sensors it is possible to determine how persons usually move within moving areas MA. Further three sensors are installed in non-moving area NMA in the upper and lower left corner as well as in the upper right corner of the shopping area A. With this sensor configuration it can be monitored how the people are moving in the whole shopping area and it can be estimated the level of crowdedness. The sensors can be for example in the middle of the area A, CO2 sensors, temperature sensors, humidity and/or noise sensors as well as proximity and moving sensors. The same may apply for the sensors in the nonmoving areas NMA.

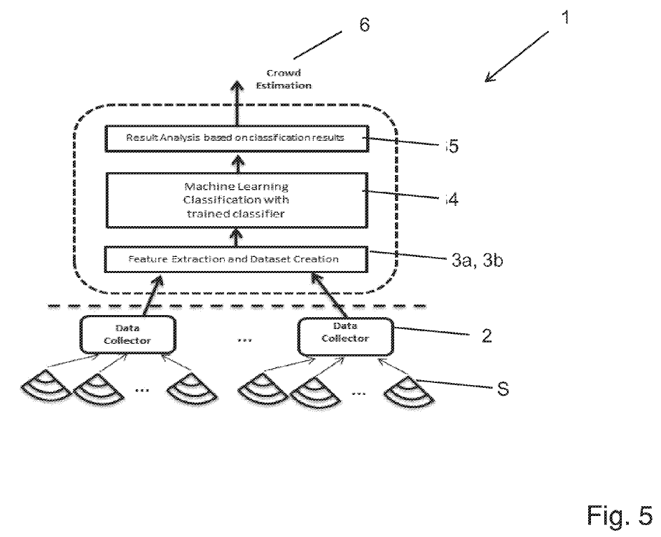

FIG. 5 shows part of the steps for crowd detection according to a sixth embodiment of the present invention. In FIG. 5, a crowd detection system architecture is shown. Data collectors 2 collect data from sensors S. The data collector 2 may be a piece of software receiving updates from the sensors S when a person P passing by activates them. The data is preferably collected in real-time and will be forwarded to a data analysis block comprising feature extraction and data set creation means 3a, 3b, a machine learning classifier 4 as well as a result analyzer 5. The feature extraction means 3a receives the data from the data collector 2 computes features. The data set creation means 3b creates a data set which can be used by the machine learning classifier 4 for predicting the crowd level. The machine learning classifier 4 is preferably a pre-trained machine learning algorithm producing—based on the input data set—a classified output. Each known machine learning algorithm can be used. The result analyzer 5 analyses the results of the machine learning classifier 4 and generates a crowd level estimation 6. For example by using conventional machine learning algorithms it is possible to estimate crowd levels, for example no crowd, less crowd, crowd and overcrowded, with an accuracy in the range of 98.6%. When using only conventional sensors like CO2 sensors, temperature or the like, accuracy can only account for 84%. Thus, an increase of accuracy from 84% to 98% is obtained by the present invention.

In summary the present invention preferably uses group behavioral dynamics results for extracting features correlated to crowd levels. Even further the present invention preferably uses distance, motion, CO2, audio, temperature and humidity sensors for enhancing detection of crowd levels. Even further the present invention preferably uses machine learning algorithms for estimating crowd levels.

The present invention further enables a crowd level estimation with sensors being inexpensive and privacy-preserving as opposed to conventional camera based methods and systems. Further, the present invention requires only a small number of sensors sampling the environment as opposed to conventional approaches controlling all entrances and exits or blanket cover the corresponding area. The accuracy for detecting crowds in an area is at least in the range of camera based conventional systems if not higher but does not suffer from accumulated error over time: If a camera system e.g. misses one person it estimates one person short until it mistakenly counts a person twice as opposed to the present invention which is based on the state of the system instead.

The present invention inter alia has the following advantages: The present invention preserves privacy, is cost-effective, enables a reuse of installations for other estimations or applications and only needs a reduced number of sensors, resulting in low installations costs compared with conventional methods and systems. The method for crowd detection in an area respectively a system for crowd detection in an area can preferably be used for
Detecting violence, e.g. persons tend move away and make room from a fight
Queue length estimation
Dimensioning and scheduling of services such as public transport or elevators
Detection of emergency situations, evacuation flow and effectiveness and crowd control
Detection of anomalies in the human behaviour for an indoor environment.

In addition combinations of different conventional technologies can be used with the present invention: A variety of interfaces including but not limited to web services REST APIs, remote method executions, etc.. Further for obtaining the model training sets multiple deployments of the system and/or combinations of these deployments and/or combinations with already existing deployments for other purposes can be used to provide generalizable training sets and even further enhanced accuracy.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for crowd detection in an area, comprising:
determining moving patterns of persons in the area and the number of persons within an/or moving from and/or to the area over a predetermined time period to obtain model training data sets;
assigning each model training data set to represent one of one or more predefined crowd levels in the area;
generating a crowd detection model based on the model training data sets; and
estimating an actual crowd level for the area using the generated crowd detection model with actual data of moving profiles and/or the actual number of persons within and/or moving from and/or to the area over the predetermined time period.

2. The method according to claim 1, wherein the crowd detection model is generated using a machine learning algorithm on the model training data sets.

3. The method according to claim 1, wherein for estimating the actual crowd level, a machine learning algorithm is used with the actual data based on the generated crowd detection model.

4. The method according to claim 1, wherein the model data sets are analyzed with regard to an association between crowd level and regions in which persons move with a probability greater than or equal to a predetermined threshold in the area and that based on the analyzed data the area is divided into one or more moving regions and one or more non-moving regions.

5. The method according to claim 4, wherein the non-moving regions are determined based on a predefined distance to one or more borders of the area.

6. The method according to claim 4, wherein one or more sensors are arranged in the non-moving regions the area.

7. The method according to claim 1, wherein one or more corridors are defined for moving to or leaving the area, wherein one or more sensors are arranged in at least one of the corridors.

8. The method according to claim 1, wherein a privacy-preserving sensor is provided in a form of one or more of an environmental sensor, a temperature sensor, a humidity sensor, a noise sensor, and a location sensor.

9. A system for crowd detection in an area comprising:
a data collector connected to one or more sensors operable to determine moving patterns of persons in the area and the number of persons within and/or moving from or to the area over a predetermined time period;
a data set creator operable to prepare the collected data of moving patterns of persons in the area and the number of persons within and/or moving from or to the area;
a classifier operable to classify one of predefined crowd levels in the area for the prepared data; and
a crowd detector operable to estimate an actual crowd level for the area based on actual data of moving profiles and/our the actual number of persons within and/or moving from or to the area over the predetermined time period.

10. The system according to claim 9, further comprising:
an analyzer operable to analyze the classified data with regard to an association between crowd level and regions in which persons move with a probability greater than or equal to a predetermined threshold in the area and that based on the analyzed data the area is divided into one or more moving regions and one or more non-moving regions.

11. The system according to claim 10, further comprising one or more sensors are arranged in the non-moving regions of the area.

12. The system according to claim 9, further comprising a privacy preserving sensor that is one or more of an environmental sensor a temperature sensor, a humidity sensor a noise sensor, and a location sensor.

13. The method according to claim 1, further comprising detecting anomaly or violence behavior.

14. The method of claim 6, wherein the one or more sensors are privacy preserving sensors.

15. The method of claim 8, wherein the environmental sensor is a CO2 sensor and wherein the location sensor is one or more of a proximity sensor and a movement sensor,

16. The system of claim 11, wherein the one or more sensors are privacy preserving sensors.

17. The system of claim 12, wherein the environmental sensor is a CO2 sensor and wherein the location sensor is one or more of a proximity sensor and a movement sensor.

18. The system of claim 9, further comprising a detector configured to detect anomaly or violence behavior.
